(19) United States
(12) Patent Application Publication
(10) Pub. No.: US 2011/0192288 A1
(43) Pub. Date: Aug. 11, 2011

(54) COFFEE MACHINE

(76) Inventors: Klaus KROESEN, Xanten (DE); Marius Hilckmann, Witten (DE); Christian Voigt, Xanten (DE)

(21) Appl. No.: 13/008,948

(22) Filed: Jan. 19, 2011

(30) Foreign Application Priority Data
Feb. 8, 2010 (DE) 102010007310.5

(51) Int. Cl. A47J 31/42

(52) U.S. Cl. 99/286

(57) ABSTRACT

In order to provide a coffee machine comprising a housing that contains the components of the machine, in particular a bean container, a grinder, at least one pump, a water container, a brewing assembly, at least one heater, power electronics with mains connection, control electronics with control modules, switches, signal lamps, display, level indicator, a beverage dispenser, a cup tray, or further components, for which design variants can be obtained at as low cost as possible, it is proposed that at the housing, there is detachably attached a head section covering an upper opening of the housing or one or two side parts that cover lateral openings of the housing or a front section forming the front of the housing, or a rear section forming the rear of the housing, or a beverage dispenser or a tray.

### FIELD OF THE INVENTION

The present invention relates to an apparatus for making a hot beverage. More particularly this invention concerns a coffee machine.

### BACKGROUND OF THE INVENTION

A typical apparatus for making a hot beverage has a housing that contains, includes or encloses the components of the machine, in particular a bean container, a grinder, at least one pump, a water container, a brewing assembly, at least one heater, power electronics with mains connection, control electronics with control modules, switches, signal lamps, display, level indicator, beverage dispenser, cup tray, and/or further components.

Coffee machines of this species are known in the art. As an example, reference is made to the CH 693 016 A5 or the EP 0 761 150 (U.S. Pat. No. 5,957,033).

Usually, such coffee machines are offered in a certain design arrangement. It is also common that several different design variants are offered, however this means high costs, since the respective machines must correspondingly be equipped and prepared in the factory.

### OBJECT OF THE INVENTION

Based on this prior art, it is the object of the invention to provide a coffee machine of the mentioned species, for which design variants can be obtained at as low cost as possible.

### SUMMARY OF THE INVENTION

For achieving this object, the invention proposes that at the housing that preferably has a substantially parallelepiped shape, there is detachably attached a head section covering an upper opening of the housing and/or one or two side parts that cover lateral openings of the housing and/or a front section forming the front of the housing, and/or a rear section forming the rear of the housing, and/or a beverage dispenser and/or a tray.

It is preferred that the detachably attached parts are provided in different design, material, configuration and/or coloring, which parts are alternatively attached at the housing.

By the respective construction, it is possible to modify or configure with little effort the appearance of a corresponding coffee machine. It is only necessary to remove the respective detachable parts and to replace them by others having a correspondingly different design impression.

Also in the case of a defect or a damage, the respective parts can easily be removed and replaced by new parts. It is also possible, with the same basic construction of an apparatus, to modify the look and the appearance, so that simple cost-effective variants and particularly outstandingly designed expensive variants can be made available with little effort.

A particularly preferred embodiment is that the housing consists of a chassis made of metal, which comprises the functional parts, and the detachably attached parts are easily detachably attached at the chassis, in particular by latching.

The chassis provides a stable base body, at which the essential machine components are attached. Only the cladding parts that form the outer surfaces, may all or partially be easily detachably attached, preferably by latching, so that they can easily be replaced or modified. Also the accessibility of the functional parts attached at the chassis is improved, since then, when service or repair jobs are required, the respective easily detachably attached parts can be removed and the apparatus components attached at the chassis are thus well accessible.

A particularly preferred embodiment is that one of the detachably attached components, preferably the head section, comprises the components: control electronics—inside—, control parts, as switches and the like—operable from outside—, signal lamps, level indicator.

By this embodiment it is possible in a simple way to also modify the control electronics according to the apparatus impression, so that different variants can be made available that can be used alternatively. Even in case that for example the control electronics is defective, a simple replacement of the control electronics is possible by removing the respective detachably attached part (including control electronics) and replacing it by a new part, which in turn includes the control electronics. The connection between the control electronics and the power electronics is preferably made in a conventional way by plug connections, so that when exchanging the parts only the electrical plug connections have to be removed or re-inserted, respectively.

Furthermore, it is preferred that the power electronics is attached at the apparatus body, in particular at the chassis, in particular a printed circuit board that comprises or carries, respectively, the components of the power electronics.

According to this embodiment, the power electronics is identical for all apparatus types, so that there is a simplification in this respect. The control of the power electronics is effected by the control electronics.

In particular, it is provided that the power electronics comprises a power/control module, by means of which all essential components of the machine can be controlled, in particular brewing assembly, pumps, heaters, grinder, and that the control electronics alternatively only comprises minimal necessary components such as switches and signal lamps or additionally or alternatively comfort components such as a display, a level indicator or other comfort components such as a user interface.

According to this embodiment, the same power electronics can be combined with different components having a control electronics, which components correspond for example to a minimal version with as few control parts as possible, an average version with several control parts or a comfort version which a big number of control parts and possibly displays and user interfaces.

The advantage of such a design is that the base apparatus can be manufactured practically identically as a universal version and can be submitted to respective tests during manufacture.

Variants of the exterior design and of the comfort impression need only to be determined at a later time, when orders with respect to corresponding production parts have been placed. Then the corresponding combination of the base apparatus with the detachable elements can be performed, so that the different types can be made available in a simple way.

If need be, it is also possible that the user simply redesigns an existing variant by ordering respective conversion elements at the manufacturer, which the user himself can then combine with the base version, in order to achieve a different appearance or a higher comfort. All in all, the number of components for the production and spare parts inventory is thereby minimized.

Further, it is preferred that the machine in addition comprises an interface for the connection of external data equipment, with the interface being connected to the connection line between power electronics and control electronics.

In order to keep the expenses of the manufacturer for research and development low and nevertheless achieve a high flexibility, the complete electronics is configured such that the voltage supply and the power control is connected with the variable control electronics only by a defined bus by means of a defined communication protocol. For example the power portion may be autonomous, i.e. it does not present any further requirements to other portions of the circuitry. With the exception of operating commands, which have to be transmitted to the power electronics, for example in order to start a brewing process with certain parameters, the power section is capable, without further electronic components, to control and monitor the complete process. Depending on the desired user comfort, different control electronics sections can be combined therewith.

The interface additionally provided interface is preferably configured as a bus system. According thereto, several modules can be operated in parallel at this bus and each of these modules can communicate with the power electronics (the power/control module) as well as with other connected units, which are present in the control electronics. This permits a maximum flexibility when designing user interfaces and optional functionalities. A coffee machine can for example be operated with an identical power section only by keys or by a graphical user interface with window system. Functionally, supplements are possible, as for example level detections or other specialties, which are part of the control electronics, respectively are operated by the latter. For test and service purposes, too, the apparatus can be connected by the interface to a PC. The control of the apparatus is then made by the PC. The control unit is not necessary here.

### BRIEF DESCRIPTION OF THE DRAWING

The above and other objects, features, and advantages will become more readily apparent from the following description, reference being made to the accompanying drawing in which:

FIG. 1 is an exploded view of a coffee machine according to the invention;

FIG. 2 is a view of components of the electronic circuitry shown as a block diagram.

### SPECIFIC DESCRIPTION

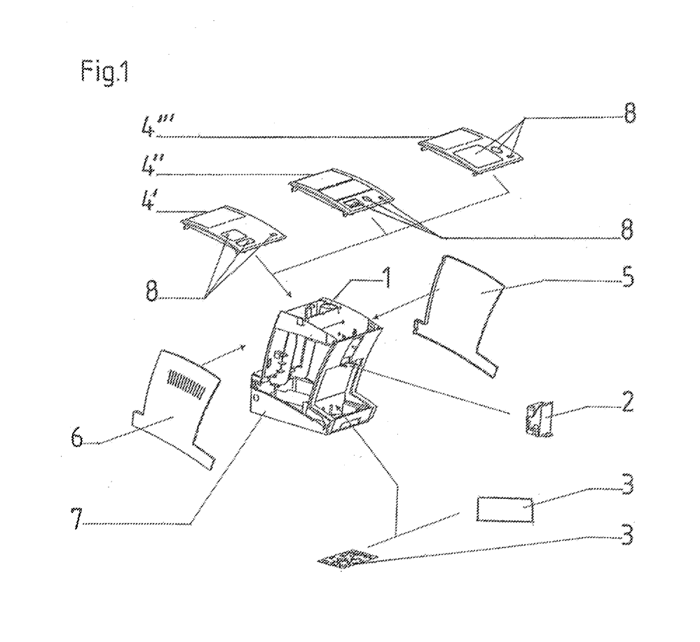

In FIG. 1, a coffee machine for preparing hot beverages is shown. It comprises a housing that contains, includes or encloses components of the machine.

In particular, a bean container, a grinder 1, at least one pump, a water container, a brewing assembly, at least one heater, and power electronics with mains connection and control electronics with control modules may be provided. In addition, a beverage dispenser 2 as well as a tray 3, if applicable a drip plate, for cups are provided.

In order to simply design the coffee machine in different ways, at the housing having a substantially parallelepiped shape a head section 4′, 4″, 4′″ covering an upper opening of the housing is provided (alternatively). Furthermore, two side parts 5, 6 are provided that cover lateral openings of the housing. Finally, in the embodiment, there is attached at the housing in a detachable manner the beverage dispenser 2 and the cup tray 3, shown in the drawing by corresponding arrows. The detachably attached parts 2 to 6 may be provided in different design, in different materials, in different configuration and/or in different coloring, so that with one and the same housing, different overall impressions of the machine can be obtained.

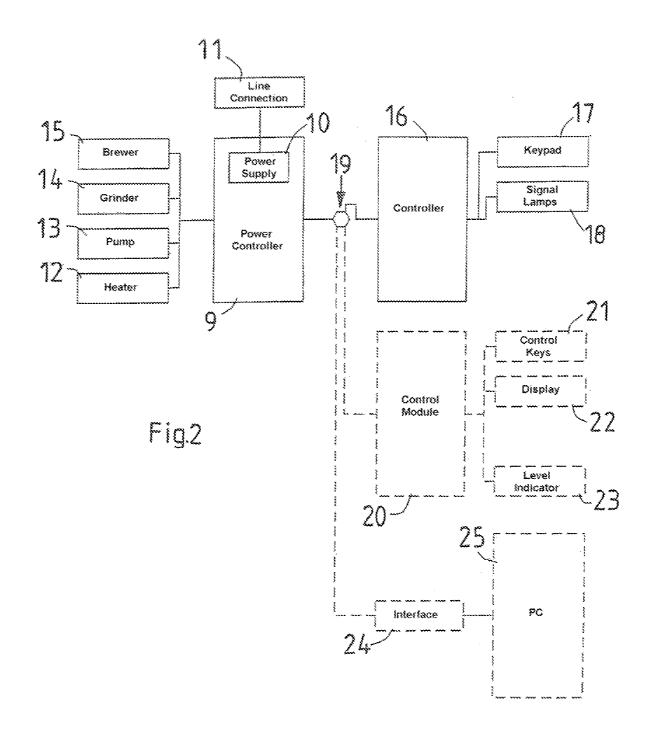

Preferably, the housing consists of a chassis 7 made of metal, which comprises the functional parts and at which the detachably attached parts 2 to 6 are attached in an easily detachable manner, for example by latching. In a particular configuration, one of the detachably attached components, in the embodiment the head section 4′, 4″, 4′″, comprises the components: control electronics (inside) as well as control parts such as switches and/or signal lamps and/or level indicators and/or displays or the like 8. The power electronics is preferably attached at the apparatus body, in particular at the chassis 7, by that for example a printed circuit board that comprises the components of the power electronics, is attached at the chassis 7. In FIG. 2, the power electronics is schematically shown, which comprises a power/control module 9, a voltage supply 10 and a mains connection 11 and communicates with the heaters 12, the pumps 13, the coffee grinder 14 and the brewing assembly 15, as shown in the drawing by corresponding cables (solid lines). The control electronics may for example consist in the simplest form of a control module 16, which is disposed at the underside of the corresponding cladding part as well as keys 17 and signal lamps 18 that are operable or visible, respectively, from outside. If the control electronics is wished to be more comfortable, another control module 20 can be connected by an interface (at 19), said other control module being combined for example with control keys 21, a graphical display 22 and a level indicator 23. In addition, the machine may be equipped with an interface 24 that communicates with the interface 19. By this interface, the power electronics can be controlled for test or service purposes, for example by means of a PC 25. Then the control unit is not required.

The invention permits to make available in a simple way coffee machines in different appearances and comforts, whereby a cost-effective manufacture is secured.

The invention is not limited to this embodiment, but is in many ways variable within the scope of the disclosure.

All novel individual or combined features disclosed in the description and/or drawing are deemed essential for the invention.

We claim:

1. In a coffee machine comprising a housing that contains, includes or encloses the components of the machine including a bean container, a grinder, at least one pump, a water container, a brewing assembly, at least one heater, power electronics with mains connection, control electronics with control modules, switches, signal lamps, a display, a level indicator, a beverage dispenser, a cup tray, or further components, the improvement wherein the housing preferably has a substantially parallelepiped shape, there is detachably attached a head section covering an upper opening of the housing or one or two side parts that cover lateral openings of the housing or a front section forming the front of the housing, or a rear section forming the rear of the housing, or a beverage dispenser or a tray.

2. The coffee machine according to claim 1, wherein the detachably attached parts are provided in different design, material, configuration or coloring, which parts are alternatively attached at the housing.

3. The coffee machine according to claim 1, wherein the housing consists of a chassis made of metal, which comprises the functional parts, and the detachably attached parts are easily detachably attached at the chassis, in particular by latching.

4. The coffee machine according to claim 1, wherein one of the detachably attached components, preferably the head section, comprises the components: control electronics—inside—, control parts, as switches and the like—operable from outside—, signal lamps, level indicator.

5. The coffee machine according to claim 1, wherein the power electronics is attached at the apparatus body, in particular at the chassis, in particular a printed circuit board that comprises or carries, respectively, the components of the power electronics.

6. The coffee machine according to claim 1, wherein the power electronics comprises a power/control module, by means of which all essential components of the machine can be controlled, in particular brewing assembly, pumps, heaters, grinder, and that the control electronics alternatively only comprises minimal necessary components such as switches and signal lamps or additionally or alternatively comfort components such as a display, a level indicator or other comfort components such as a user interface.

7. The coffee machine according to claim 1, wherein the machine in addition comprises an interface for the connection of external data equipment, with the interface being connected to the connection line between power electronics and control electronics.
